(19) United States
(12) Patent Application Publication
(10) Pub. No.: US 2016/0341095 A1
(43) Pub. Date: Nov. 24, 2016

(54) WASTE HEAT UTILIZATION ARRANGEMENT OF AN INTERNAL COMBUSTION ENGINE

(71) Applicant: Robert Bosch GmbH, Stuttgart (DE)

(72) Inventors: Anselm Koch, Stuttgart (DE); Eberhard Maier, Koengen (DE)

(21) Appl. No.: 15/158,758

(22) Filed: May 19, 2016

(30) Foreign Application Priority Data
May 19, 2015 (DE) 10 2015 209 091.4

(51) Int. Cl. F01N 5/02; F02M 26/14; F25B 5/02; F25B 43/00; F25B 45/00; F25B 41/04; F01N 13/08; B60H 1/20

(52) U.S. Cl. CPC F01N 5/02; F01N 13/08; F02M 26/14; B60H 1/20; F25B 43/003; F25B 45/00; F25B 41/043; F25B 41/04; F25B 5/02

(57) ABSTRACT

Waste heat utilization arrangement (1) of an internal combustion engine (50), comprising a main circuit (2) which carries a working medium, wherein a feed pump (6), an evaporator (10), an expansion machine (3) and a condenser (4) are disposed in the main circuit (2) in the direction of flow of the working medium. The evaporator (10) is also disposed in an exhaust duct (53) of the internal combustion engine (50). The waste heat utilization arrangement (1) comprises a secondary line (20) which can be connected to the main circuit (2). A filter element (5) is disposed in the secondary line (2b, 20, 30).

### BACKGROUND OF THE INVENTION

The invention relates to a waste heat utilization arrangement of an internal combustion engine.

Waste heat utilization arrangements of internal combustion engines are known from the prior art, such as, for example, from the published Japanese patent application JP 11-093689 A. The known waste heat utilization arrangement of an internal combustion engine comprises a main circuit which carries a working medium, a feed pump, an evaporator, an expansion machine and a condenser being disposed in the main circuit in the direction of flow of the working medium. The evaporator is also disposed in an exhaust duct of the internal combustion engine; thus enabling the thermal energy of the exhaust to evaporate the working medium in the evaporator.

The known waste heat utilization arrangement further comprises a filter element in the main circuit so that the working medium is continually filtered. The filter element therefore has a continuous pressure loss in the main circuit. As a result, the efficiency of the entire waste heat utilization arrangement is reduced.

### SUMMARY OF THE INVENTION

The inventive waste heat utilization arrangement of an internal combustion engine has in contrast the advantage that the filter element is advantageously disposed outside of the main circuit in a secondary line. As a result, a drop in pressure does not occur in the main circuit on account of the filter element. The waste heat utilization arrangement is therefore more efficient.

To this end, the waste heat utilization arrangement of an internal combustion engine comprises a main circuit which carries a working medium, wherein a feed pump, an evaporator, an expansion machine and a condenser are arranged in the direction of flow of the working medium in the main circuit. The evaporator is also disposed in an exhaust duct of the internal combustion engine. The waste heat utilization arrangement further comprises a secondary line which can be connected to the main circuit. According to the invention, a filter element is disposed in the secondary line.

By disposing the filter element in the secondary line, a loss of pressure does not occur in the main line. A smaller mass flow of the working medium flows on average through the secondary line or, respectively, flows less frequently through said secondary line as through the main circuit. In total, the efficiency of the waste heat utilization arrangement is thus increased. In so doing, a sufficient mass flow always flows through the secondary line for the filter function. This can also, for example, take place only at the beginning or only at the end of the operation of the internal combustion engine.

In an advantageous embodiment, a tank for the working medium can be connected to the main circuit via the secondary line. The working medium preferably flows through the secondary line only when starting up the internal combustion engine. As a result, a loss of pressure at the filter element occurs only at the beginning of the operation of the waste heat utilization arrangement. The filtering action of the filter element is nevertheless sufficient because the waste heat utilization arrangement is sufficiently sealed off to the surrounding environment, i.e. is only exposed to comparatively low contamination.

In an advantageous modification to the invention, the secondary line comprises a parallel circuit including a supply line from the tank to the main circuit and a return line from the main circuit to the tank. As a result, the mass flows to the main circuit and back to the tank can be controlled in a simple manner by two different valve arrangements.

The filter element is advantageously disposed in the return line. In so doing, the working medium is cleaned primarily at the beginning of the operation of the internal combustion engine, i.e. when starting up the system of the heat utilization arrangement. As a result, possible contaminants are filtered out at the beginning of the operation. When starting up the internal combustion engine or, respectively, the waste heat utilization arrangement, the steam portion of the working medium is increased in the main circuit, which results in a volumetric increase in the working medium. Hence, working medium flows through the secondary line or, respectively, the return line when starting up the engine.

The filter element is alternatively disposed in the supply line. This is particularly advantageous if contaminants are present in the tank in order to protect the main circuit from these contaminants.

In advantageous modifications to the invention, a valve arrangement is disposed in the return line, which blocks fluid from flowing from the tank through the return line to the main circuit. In this configuration, the filter element is preferably disposed in the return line. It is thus ensured that the working fluid flows through the filter element only in one direction.

The filter element and the valve arrangement are advantageously arranged in a common housing. As a result, the filter element is embodied in a manner that is both cost effective and saving of installation space.

In an alternative, advantageous embodiment, the secondary line is connected in parallel to the evaporator and a further evaporator is disposed in the secondary line. In a preferable manner, less working medium flows on average through the further evaporator than through the evaporator. As a result, also comparatively little working medium flows through the filter element. This amount of working medium flowing through the filter element is through nevertheless sufficient to achieve an adequate filtering effect.

The exhaust duct advantageously has a return duct to the internal combustion engine for the exhaust, and the further evaporator is disposed in the return duct. The return duct is a partial duct of the exhaust duct. As a result, the efficiency of the entire waste heat utilization arrangement is further increased.

In advantageous embodiments of the invention, a distribution valve controls the mass flows to the evaporator. In so doing, the exhaust gas thermal energy in the two evaporators is, on the one hand, introduced in the best possible way into the main circuit. On the other hand, the distribution valve can however be actuated in a targeted manner such that the mass flow of the working medium is fed through the further evaporator—and thus through the filter element—in order to traverse a cleaning cycle.

The filter element and the distribution valve are advantageously disposed in a common housing. The filter element is thus embodied in a manner that is cost effective and saves installation space.

In a further alternative advantageous embodiment, a main control valve is disposed in the main circuit, and the secondary line is disposed parallel to the main control valve. The main control valve preferably controls the mass flow of the working medium downstream of the feed pump. When cleaning is required, the secondary line can thus be actuated and the working medium can be filtered.

In advantageous embodiments of the invention, the parallel circuit of the main control valve and the secondary line is disposed between the feed pump and the evaporator or, respectively, between the feed pump and the parallel circuit including a plurality of evaporators. The mass flow through the main control valve can thus be very efficiently set as a function of the quantities of exhaust gas heat available in the evaporators.

In advantageous modifications to the invention, a check valve is disposed upstream of the filter element in the secondary line, the check valve blocking a mass flow opposite to the direction of flow of the working medium. It is thereby ensured that the working medium can only flow in one direction through the filter element. Working medium preferably flows through the filter element in a direction from the feed pump to the evaporator.

The filter element and the check valve are advantageously disposed in a common housing. As a result the filter element can be embodied in a manner that is cost effective and saves installation space.

In advantageous embodiments of the invention, the filter element is designed as an inline filter. In so doing, the filter element can be very easily disposed at any location in the duct system of the waste heat utilization arrangement. The inline filter is thus advantageously screwed into the duct or fastened with screws to two partial duct pieces.

### BRIEF DESCRIPTION OF THE DRAWINGS

In the drawings:

FIG. 1 shows schematically an inventive waste heat utilization arrangement of an internal combustion engine, wherein only the essential regions are depicted;

FIG. 2 shows a further embodiment of the waste heat utilization arrangement according to the invention;

FIG. 3 shows the portion III of FIG. 2 in a further exemplary embodiment; and

FIG. 4 shows a further embodiment of the waste heat utilization arrangement according to the invention.

### DETAILED DESCRIPTION

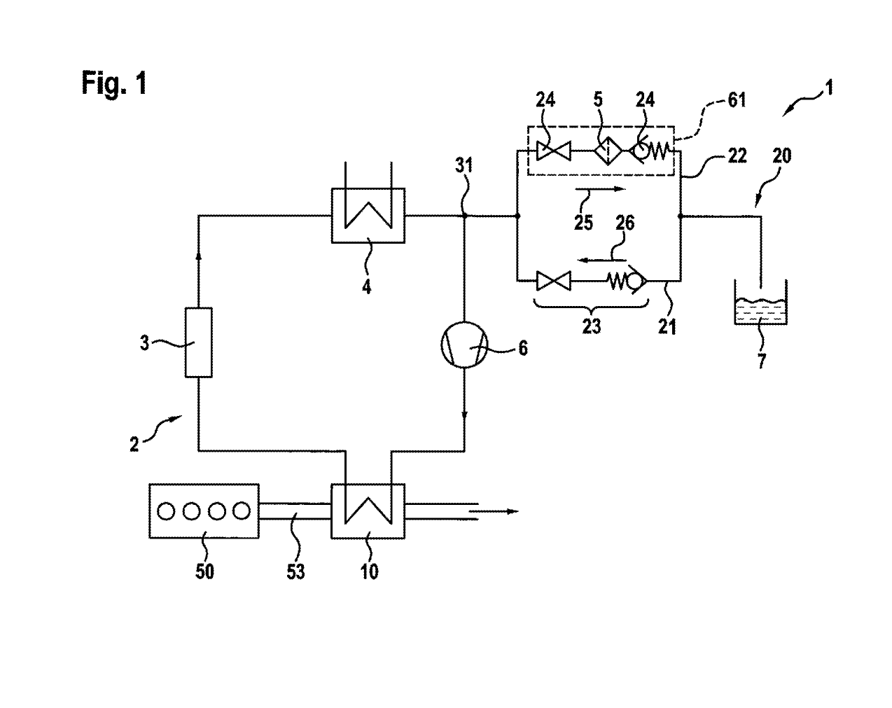

FIG. 1 shows schematically a waste heat utilization arrangement 1 of an internal combustion engine 50 comprising a main circuit 2 which carries a working medium and a secondary line 20 which can be connected to the main circuit.

Fresh air, which can also contain recirculated exhaust gas of the internal combustion engine 50, is supplied to the internal combustion engine 50 on the input side. On the output side, the internal combustion engine 50 has an exhaust duct 53 through which the exhaust gas is discharged from said internal combustion engine 50.

The main circuit 210 comprises a feed pump 6, an evaporator 10, an expansion machine 3 and a condenser 4 in the direction of flow of the working medium. The evaporator 10 is simultaneously disposed in the exhaust duct 53; thus enabling the thermal energy of the exhaust gas to be transferred out of the exhaust duct 53 into the main circuit 2.

The waste heat utilization arrangement 1 further comprises a secondary line 20, which is connected to a tank 7 for the working medium. The secondary line 20 opens into the main circuit 2 at a connection point 31 which is disposed between the condenser 4 and the feed pump 6. The secondary line 20 comprises a parallel circuit including a supply line 21 and a return line 22. The supply line 21 has a first valve arrangement 23, and the return line 22 has a second valve arrangement 24. The two valve arrangements 23, 24 are designed in such a way that working medium is fed in a direction of inflow 26 from the tank 7 via the supply line 21 into the main circuit 2 and is fed back in a direction of return flow 25 from the main circuit 2 via the return line 22 into the tank 7. The two valve arrangements 23, 24 thereby preferably comprise a check valve and a return valve, alternatively a throttle. The check valve blocks respectively one direction of flow, and the control valve controls the mass flow in the opposite direction of flow.

According to the invention, a filter element 5 is disposed in the return line 22. As a result, the working medium is only filtered when being returned to the tank 7, i.e. primarily at the beginning of the operating cycles of the waste heat utilization arrangement 1 or, respectively, of the internal combustion engine 50 if the steam component of the working medium is increased in the main circuit 2. Hence, flow losses do not occur due to the filter arrangements in the main circuit 2. In the exemplary embodiment of FIG. 1, the filter element 5 is disposed between the check valve and the control valve or, respectively, the throttle of the second valve arrangement 24 in the return line 22. In other embodiments, the filter element 5 can, however, can also be disposed within the return line 22 in the return flow direction 24 upstream or downstream of the second valve arrangement 24. In this case, the filter element 5 is advantageously installed in a housing 61 together with the second valve arrangement 24. In further embodiments, the filter element 5 can also be positioned within the return line 21.

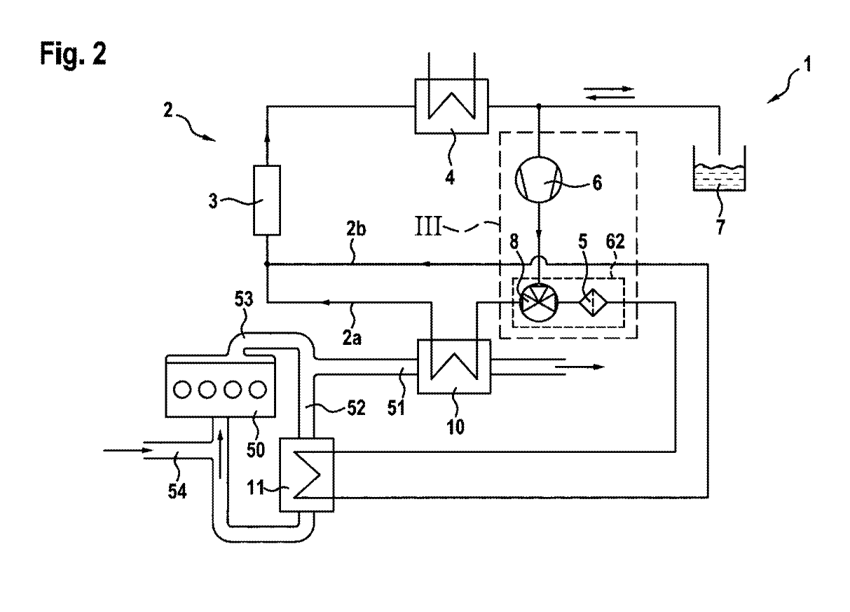

FIG. 2 shows a further embodiment of the waste heat utilization arrangement 1 according to the invention. The following discussion relates however only to the differences with respect to the exemplary embodiment of FIG. 1.

In the embodiment of FIG. 2, the main circuit 2 comprises the evaporator 10 and a further evaporator 11, which are arranged in a parallel circuit. A distribution valve 8 controls the mass flows of the working medium supplied by the feed pump 6 to the two evaporators 10, 11, wherein the evaporator 10 is disposed in a first branch line 2a and the further evaporator 11 in a second branch line 2b. The two mass flows are rejoined upstream of the expansion machine 3. In extreme operating situations, the mass flow of the working medium can be controlled by the distribution valve 8 in such a way that the supply of said medium is stopped to one of the branch lines 2a, 2b or the supply is even stopped to both branch lines 2a, 2b.

In the exemplary embodiment of FIG. 2, the exhaust duct 53 of the internal combustion engine 50 comprises an end duct 51 and a return duct 52. The end duct 51 delivers the exhaust gas discharged by the internal combustion engine 50 to the atmosphere, if applicable by interposing aftertreatment systems that are not depicted. The return duct 52 delivers a portion of the discharged exhaust gas back to the internal combustion engine 50. In so doing, the return duct 52 merges with a fresh air duct 54 so that the internal combustion engine 50 is supplied with a mixture of air and exhaust gas. The splitting up of the exhaust gas mass flow to the end duct 51 and to the return duct 52 is controlled by a valve that is not depicted.

The evaporator 10 is disposed in the end duct 51 and the further evaporator 11 in the return duct 52. Typically more exhaust gas flows through the end duct 51 than through the return duct 52 so that more working medium can be evaporated in the evaporator 10 than in the further evaporator 11. For that reason, the distribution valve 8 controls the mass flow of the working medium in most cases such that more working medium is led through the first branch line 2a than through the second branch line 2b. The average mass flow through the second branch line 2b is thus less, in many applications even considerably less, than the average mass flow through the first branch line 2a. In this embodiment, the filter element is thus, in accordance with the invention, disposed in the second branch line 2b, through which less working medium flows, in order to reduce the flow losses when working medium passes through the filter element 5. The branch line 2b through which less working medium passes can also accordingly be denoted as the secondary line in this embodiment.

In advantageous embodiments, the filter element 5 can, for example, be screwed into the second branch line 2b as an inline filter; or the filter element 5 can also be jointly disposed in a housing 62 with the distribution valve 8.

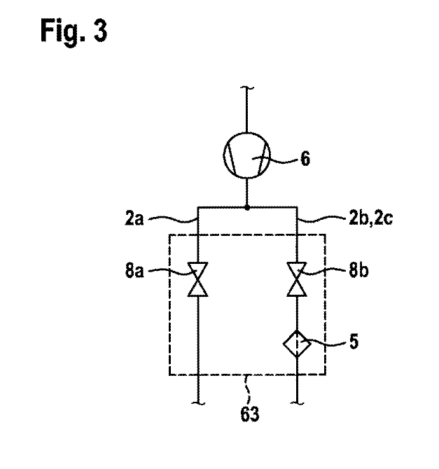

FIG. 3 shows the portion III of FIG. 2 in a further exemplary embodiment. Instead of the distribution valve 8 as in the exemplary embodiment of FIG. 2, a first control valve 8a and a second control valve 8b are used in this embodiment. The first control valve 8a controls the mass flow of the working medium into the branch line 2a to the evaporator 10. The second control valve 8b controls the mass flow of the working medium into the second branch line 2b or, respectively, into the secondary line 20 to the further evaporator 11. The filter element 5 is thereby disposed in the secondary line 20 downstream of the second control valve 8b.

In advantageous embodiments, the filter element 5 and the two control valves 8a, 8b are disposed in a common housing. In further advantageous embodiments, the feed pump 6, the filter element 5 and the two control valves 8a, 8b are disposed in a common housing 63.

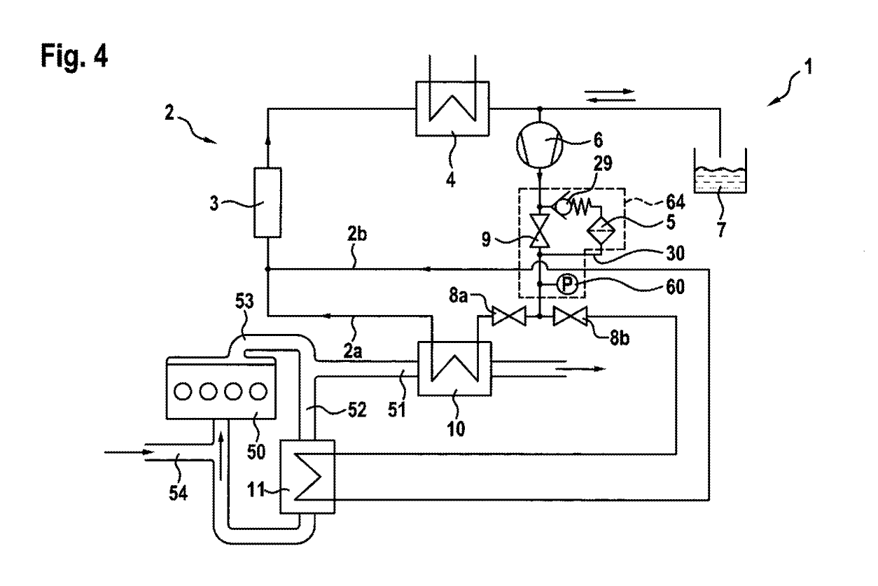

FIG. 4 shows a further embodiment of the waste heat utilization arrangement 1 according to the invention. The waste heat utilization arrangement 1 of FIG. 4 is designed similarly to the exemplary embodiment of FIG. 3. Hence, the following description relates only to the differences between the two embodiments.

In this embodiment, the main circuit 2 also comprises a parallel circuit including two evaporators 10, 11, i.e. comprising the first branch line 2a and the second branch line 2b. The first control valve 8a controls the mass flow of the working medium into the first branch line 2a to the evaporator 10. The second control valve 8b controls the mass flow of the working medium into the second branch line 2b to the further evaporator 11. A main control valve 9 is disposed upstream of these two control valves 8a, 8b, said main control valve controlling the total mass flow of the working medium of the parallel circuit of the two branch lines 2a, 2b.

According to the invention, a bypass line or, respectively, a secondary line 30, in which the filter element 5 is in turn arranged, is disposed parallel to the main control valve 9. A check valve 29 is further disposed in the secondary line 30 upstream of the filter element 5, said check valve allowing only a flow of the working medium from the feed pump 6 to the two evaporators 10, 11 but not in the opposite direction. In this embodiment, the main control valve 9 can control the flow of the working medium through the secondary line 30 and therefore also through the filter element 5.

A pressure sensor is advantageously disposed between the main control valve 9 and the parallel circuit including the two branch lines 2a, 2b. By measuring the pressure in the main circuit 2 at this point, the loading condition of the filter element 5 can be checked: the pressure is measured once if the secondary line 30 is connected and once if the secondary line 30 is blocked for the working medium. The loading condition is subsequently ascertained using the pressure difference from the two measurements.

In advantageous embodiments, the main control valve 9, the filter element 5, the check valve 29 and optionally the pressure sensor 60 are disposed in a common housing 64.

In advantageous embodiments, a distribution valve is used instead of the two control valves 8a, 8b, which controls the mass flows into the two branch lines 2a, 2b.

The functionality of the waste heat utilization arrangement 1 operates as follows:

The feed pump 6 delivers liquid working medium from the tank 7 into the evaporator 10 and if applicable into the further evaporator 11. The working medium is isobarically evaporated in the evaporator 10 or in the two evaporators 10, 11 and subsequently supplied to the expansion machine 3. In the expansion machine 3, the gaseous working medium is expanded and generates thereby a mechanical power, which, for example, can be delivered in the form of a torque to an output shaft of the internal combustion engine 50 or to a generator. The working medium is subsequently again liquefied in the condenser 4. The liquid working medium is subsequently supplied again to the feed pump 6 or also to the tank 7 (for example when shutting down the internal combustion engine 50).

According to the invention, the filter element 5 is now disposed outside of the main circuit 2 in a secondary line 2b, 20, 30 and in fact in such a way that a sufficient amount of working medium is passed through said filter element in order to achieve an adequate filtering effect; however, not to the point where a constant or too large a drop in pressure occurs at the filter element 5. The filtering of the working medium of the waste heat utilization arrangement 1 is thus very efficiently designed.

Particularly advantageous positions for the arrangement of the filter element 5 in the waste heat utilization arrangement 1 outside of the main circuit 2 are:
the supply line 21 from the tank 7 into the main circuit 2 or the return line 22 from main circuit into the tank 7.
in the second branch line 2b which is connected in parallel to the evaporator 10 and comprises a further evaporator 11. In this case, less working medium passes through the further evaporator 11 than the evaporator 10.
in the bypass line or secondary line 30 connected in parallel to the main circuit valve 9.

What is claimed is:

1. A waste heat utilization arrangement (1) of an internal combustion engine (50), the arrangement comprising a main circuit (2) carrying a working medium, wherein a feed pump (6), an evaporator (10), an expansion machine (3) and a condenser (4) are disposed in the main circuit (2) in a direction of flow of the working medium, the evaporator (10) also being disposed in an exhaust duct (53) of the internal combustion engine (50), wherein the waste heat utilization arrangement (1) comprises a secondary line (2b, 20, 30) connected to the main circuit (2), and wherein a filter element (5) is disposed in the secondary line (2b, 20, 30).

2. The waste heat utilization arrangement (1) according to claim 1, characterized in that a tank (7) for the working medium is connected via the secondary line (20) to the main circuit (2).

3. The waste heat utilization arrangement (1) according to claim 1, characterized in that the secondary line (20) comprises a parallel circuit including a supply line (21) from the tank (7) to the main circuit (2) and a return line (22) from the main circuit (2) to the tank (7).

4. The waste heat utilization arrangement (1) according to claim 3, characterized in that the filter element (5) is disposed in the return line (22).

5. The waste heat utilization arrangement (1) according to claim 4, characterized in that a valve arrangement (24) is disposed in the return line (22), wherein the valve arrangement blocks working medium from passing through the return line (22) from the tank (7) to the main circuit (2).

6. The waste heat utilization arrangement (1) according to claim 5, characterized in that the filter element (5) and the valve arrangement (24) are arranged in a common housing.

7. The waste heat utilization arrangement (1) according to claim 1, characterized in that the secondary line (2b) is connected in parallel to the evaporator (10) and that a further evaporator (11) is disposed in the secondary line (2b).

8. The waste heat utilization arrangement (1) according to claim 7, characterized in that the exhaust duct (53) has a return duct (52) to the internal combustion engine (50) for the exhaust gas, the further evaporator (11) being disposed in the return duct (52).

9. The waste heat utilization arrangement (1) according to claim 7, characterized in that a distribution valve (8) controls the mass flows to the evaporator (10) and to the further evaporator (11).

10. The waste heat utilization arrangement (1) according to claim 9, characterized in that the filter element (5) and the distribution valve (8) are disposed in a common housing.

11. The waste heat utilization arrangement (1) according to claim 1, characterized in that a main control valve (9) is disposed in the main circuit (2) and that the secondary line (30) is disposed parallel to the main control valve (9).

12. The waste heat utilization arrangement (1) according to claim 11, characterized in that the parallel circuit including the main control valve (9) and the secondary line (30) is disposed between the feed pump (6) and the evaporator (10).

13. The waste heat utilization arrangement (1) according to claim 11, characterized in that a check valve (29) is disposed upstream of the filter element (5) in the secondary line (30), the check valve (29) blocking a mass flow opposite to the direction of flow of the working medium.

14. The waste heat utilization arrangement (1) according to claim 13, characterized in that the filter element (5) and the check valve (29) are disposed in a common housing.

15. The waste heat utilization arrangement (1) according to claim 1, characterized in that the filter element (5) is an inline filter.

16. The waste heat utilization arrangement (1) according to claim 8, characterized in that a distribution valve (8) controls the mass flows to the evaporator (10) and to the further evaporator (11).

17. The waste heat utilization arrangement (1) according to claim 16, characterized in that the filter element (5) and the distribution valve (8) are disposed in a common housing.

18. The waste heat utilization arrangement (1) according to claim 12, characterized in that a check valve (29) is disposed upstream of the filter element (5) in the secondary line (30), the check valve (29) blocking a mass flow opposite to the direction of flow of the working medium.

19. The waste heat utilization arrangement (1) according to claim 18, characterized in that the filter element (5) and the check valve (29) are disposed in a common housing.
